(19) United States
(12) Patent Application Publication
(10) Pub. No.: US 2026/0016989 A1
(43) Pub. Date: Jan. 15, 2026

(54) COMMAND AND ADDRESS SAMPLING

(71) Applicant: Micron Technology, Inc., Boise, ID (US)

(72) Inventors: Erick Guerrero Rodriguez, Unterhaching (DE); Maksim Kuzmenka, München (DE); Filippo Vitale, Dachau (DE); Martin Brox, München (DE)

(21) Appl. No.: 19/250,175

(22) Filed: Jun. 26, 2025

Related U.S. Application Data
(60) Provisional application No. 63/671,535, filed on Jul. 15, 2024.

(51) Int. Cl. G06F 3/06

(52) U.S. Cl. CPC G06F 3/0659; G06F 3/0604; G06F 3/0638

(57) ABSTRACT

Methods, systems, and devices for command and address (CA) sampling are described. A memory system may implement a sampler that performs a first comparison of a CA sample with a first reference voltage and a second comparison of a CA sample with a second reference voltage. Such comparisons may be performed at the memory system using a first decision circuit and a second decision circuit. The memory system may determine to activate one of the first decision circuit or the second decision circuit based on a value of a previous CA sample. After activating the respective decision circuit, an output of the decision circuit may be input to a latch circuit, and the latch may determine a logical value of the CA sample. The latch circuit may send the output of the latch circuit as feedback to the first decision circuit and the second decision circuit.

### CROSS REFERENCE

The present Application for Patent claims priority to U.S. patent application Ser. No. 63/671,535 by Guerrero Rodriguez et al., entitled “COMMAND AND ADDRESS SAMPLING,” filed Jul. 15, 2024, which is assigned to the assignee hereof, and which is expressly incorporated by reference in its entirety herein.

### TECHNICAL FIELD

The following relates to one or more systems for memory, including command and address (CA) sampling.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports command and address (CA) sampling in accordance with examples as disclosed herein.

FIG. 2 shows an example of an architecture that supports CA sampling in accordance with examples as disclosed herein.

FIG. 3 shows a block diagram of a memory system that supports CA sampling in accordance with examples as disclosed herein.

FIG. 4 shows a flowchart illustrating a method or methods that support CA sampling in accordance with examples as disclosed herein.

### DETAILED DESCRIPTION

In some memory systems, communication may be supported over one or more channels between a host system and a memory system, and the memory system may use sampling circuitry to receive or latch command and address (CA) signals that are received from the host system via a CA channel. In some sampling architectures, the CA channel may be operated at a relatively high speed, which may prevent the host system from transmitting full rail signals to the memory system, causing errors in decoding the CA signal at the memory system. To mitigate the decoding errors caused by non-full rail signals, the memory system may perform pre-amplification on the CA signals prior to sampling. For example, the CA signals may pass through a pre-amplifier, and the amplified CA signals may be input to the sampling circuitry of the memory device. However, introducing a pre-amplifier to the memory system may increase processing power, increase latencies associated with the processing and/or execution of CA signals, occupy excessive space in the memory system, among other inefficiencies.

In accordance with examples described herein, the memory system may implement sampling circuitry that performs a first comparison of a CA signal with a first reference voltage, which is positively offset from a default reference voltage (e.g., reference voltage for decoding of full-rail signals) and a second comparison of a CA signal with a second reference voltage, which may be negatively offset from the default reference voltage. Such comparisons may be performed at the memory system using a first decision circuit (e.g., a first circuit of a differential pair) and a second decision circuit (e.g., a second circuit of a differential pair). The memory system may determine to activate one of the first decision circuit or the second decision circuit based on a value of a previous sample. For example, in cases where the previous CA sample is high, the memory system may perform a comparison of the CA signal with the positively offset reference voltage. In other cases, where the previous CA sample is low, the memory system may perform a comparison of the CA signal with the negatively offset reference voltage. After activating the respective decision circuit, an output of the decision circuit may be input to a latch circuit (e.g., a strong advanced reduced instruction set computer (RISC) machine (strongARM) latch), and the latch may determine a logical value of the CA signal. The latch circuit may send the output of the latch circuit (e.g., a CA sample) as feedback to the first decision circuit and the second decision circuit to determine which of the first decision circuit or the second decision circuit to activate for processing of the subsequent CA signal.

By performing sampling of the CA signal using the first and second decisions circuit and the latch, the memory system may support accurate and efficient sampling of non-full rail signals. The techniques described herein may reduce errors in decoding in cases where the CA channel is operated at a high speed, which may support reduced latencies and increased throughput of access operations in the memory system. By omitting the pre-amplifier from the sampling circuitry, the memory system may support an increased capacity of memory due to freeing up additional space in the memory system.

In addition to applicability in memory systems as described herein, techniques for CA sampling may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds and by reducing a footprint of sampling circuitry within memory systems, which may decrease processing or latency times, improve response times, or otherwise improve user experience, among other benefits.

Features of the disclosure are illustrated and described in the context of systems. Features of the disclosure are further illustrated and described in the context of architectures, block diagrams, and flowcharts.

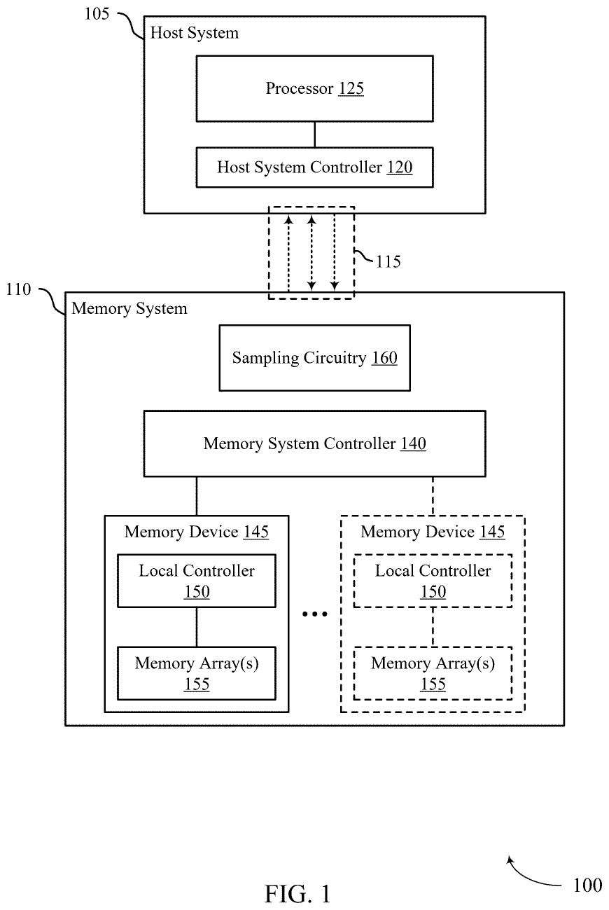

FIG. 1 illustrates an example of a system 100 that supports CA sampling in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

Signaling may be communicated over the channels 115 using single data rate (SDR) signaling or double data rate (DDR) signaling, among other rates (e.g., relative to a clock signal). In SDR signaling, one modulation symbol (e.g., signal level) of a signal may be registered for each clock cycle (e.g., on a rising edge or a falling edge of a clock signal). In DDR signaling, two modulation symbols of a signal may be registered for each clock cycle (e.g., on both a rising edge and a falling edge of a clock signal).

The memory system 110 may receive CA signals from the host system 105 via the CA channel (e.g., a channel 115), and the CA signals may be sampled at a sampling circuitry 160. In some examples, the CA signals may pass through (e.g., be subjected to, be coupled with) a pre-amplifier prior to being received at the sampling circuitry 160, which may increase an amplitude of the CA signal.

In some memory systems 110, communication may be supported over one or more channels 115 between a host system 105 and a memory system 110, and the memory system 110 may use sampling circuitry 160 to receive or latch command and address (CA) signals that are received from the host system 105 via a CA channel (e.g., a channel 115). In some sampling architectures, the CA channel may be operated at a relatively high speed, which may prevent the host system 105 from transmitting full rail signals to the memory system 110, causing errors in decoding the CA signal at the memory system 110. To mitigate the decoding errors caused by non-full rail signals, the memory system may perform pre-amplification on the CA signals prior to sampling. For example, the CA signals may pass through a pre-amplifier, and the amplified CA signals may be input to the sampling circuitry of the memory system 110. However, introducing a pre-amplifier to the memory system 110 may increase processing power, increase latencies associated with the processing and/or execution of CA signals, occupy excessive space in the memory system, among other inefficiencies.

In accordance with examples described herein, the memory system 110 may implement sampling circuitry 160 that performs a first comparison of a CA signal with a first reference voltage, which is positively offset from a default reference voltage (e.g., reference voltage for decoding of full-rail signals) and a second comparison of a CA signal with a second reference voltage, which may be negatively offset from the default reference voltage. Such comparisons may be performed at the memory system 110 using a first decision circuit (e.g., a first circuit of a differential pair) and a second decision circuit (e.g., a second circuit of a differential pair). The memory system 110 may determine to activate one of the first decision circuit or the second decision circuit based on a value of a previous CA sample. For example, in cases where the previous CA sample is high (e.g., a value of 1), the memory system may perform a comparison of the CA signal with the positively offset reference voltage. In other cases, where the previous CA sample is low (e.g., a value of 0), the memory system 110 may perform a comparison of the CA signal with the negatively offset reference voltage. After activating the respective decision circuit, an output of the decision circuit may be input to a latch circuit (e.g., a strong advanced reduced instruction set computer (RISC) machine (strongARM) latch), and the latch may determine a logical value of the CA signal. The latch circuit may send the output of the latch circuit (e.g., a CA sample) as feedback to the first decision circuit and the second decision circuit to determine which of the first decision circuit or the second decision circuit to activate for processing of the subsequent CA signal.

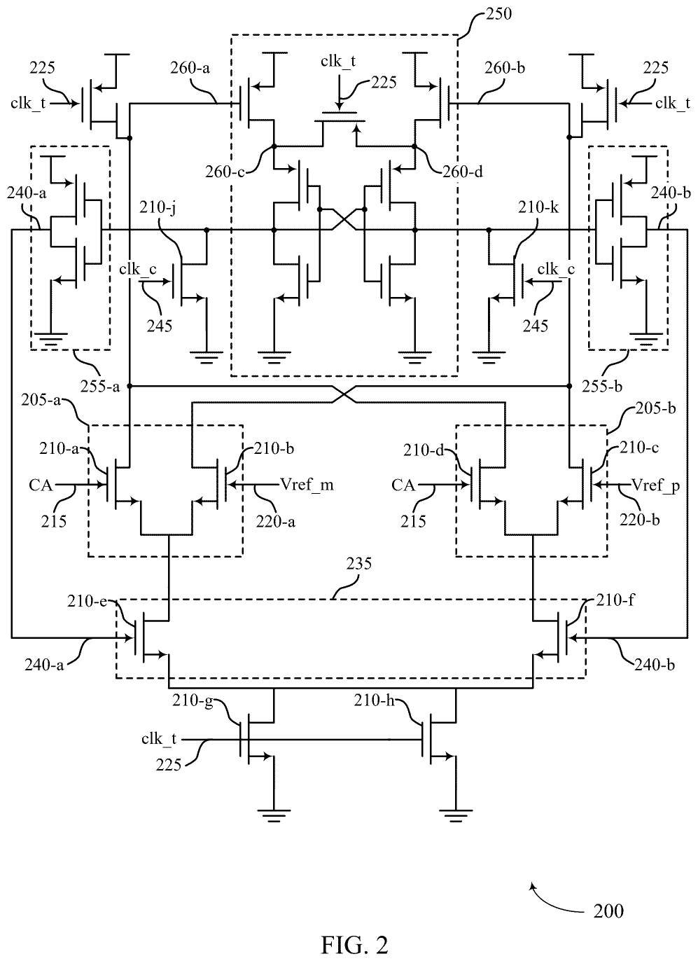

FIG. 2 shows an example of an architecture 200 that supports CA sampling in accordance with examples as disclosed herein. The architecture 200 may implement or may be implemented by aspects of the system 100. For example, the architecture 200 may be implemented by sampling circuitry 160, as described with reference to FIG. 1.

In some examples, a memory system may sample a CA signal 215 via a CA channel. The memory system may support relatively high sampling rates (e.g., a high frequency of samples) via the CA channel, which may support increased memory access speeds. However, sampling the CA channel at a high sampling rate may result in CA signals that do not achieve a full swing in the signal. A signal swing may refer to the range of voltage values (e.g., amplitude of voltage) a signal may exhibit. If binary modulation is being used for a signal, then full-rail swings of the signal may refer to the signal changing from a first defined value associated with a first logic state (e.g., a ‘0’) to a second defined value associated with a second logic state (e.g., a ‘1’). Given a certain set of components, it may take a signal a minimum duration to fully transition from a first defined value to a second defined value. In some systems, the sampling rate for the signal may result in a sample duration that is shorter than the minimum duration to fully transition. Thus, as the sampling rate increases for a signal, the signal may not have enough time between samples to fully transition from one of the defined values to the other defined value. In such cases, the signal may be sampled before the signal fully transitions to the intended defined state.

Sampling signals using a sampling duration that is less than a minimum duration to fully swing from a first defined value to a second defined value may result in increased errors in the signal. Thus, as sampling rates increase for CA signals, the CA signals may cease exhibiting full-rail swing characteristics (e.g., a CA signal that spans a full range of defined values) to exhibiting non-full-rail swing characteristics (e.g., a CA signal that is sampled before it has had time to transition from a first defined value to a second defined value). In some examples, to mitigate the impacts to CA signals while operating at a high sampling rate, a memory system may perform amplification of the CA signal prior to sampling using a pre-amplifier. However, an addition of a pre-amplifier to support CA signaling may increase power consumption, occupy excessive space in the memory system, and reduce latency. In accordance with the architecture 200, the memory system may support sampling of non-full-rail CA signals by adjusting a reference voltage up or down (e.g., using the reference voltage 220-a and the reference voltage 220-b) based on historical results of the CA sampling (e.g., consecutive values of the CA sample being high or low during prior unit intervals).

At each unit interval of a clock signal 225 (e.g., rising edge of a clock signal 225, falling edge of a clock signal 225), the memory system may sample a CA signal 215. A unit interval may refer to a time interval between sampling the CA signal. The CA signal 215 may be received at a decision circuit 205-a and at a decision circuit 205-b. The decision circuit 205-a may receive the CA signal at a switching component 210-a. The decision circuit 205-a may receive a reference voltage 220-a at a switching component 210-b. The switching component 210-a and the switching component 210-b may be NMOS transistors. The decision circuit 205-a and the decision circuit 205-b may be an example of at least a portion of a decision feedback equalization (DFE) circuit.

The decision circuit 205-a may compare the CA signal 215 with the reference voltage 220-a, and an output of the decision circuit 205-a may be based on the comparison. The decision circuit 205-b may receive the CA signal at a switching component 210-d. The decision circuit 205-b may receive a reference voltage 220-b at a switching component 210-c. The switching component 210-c and the switching component 210-d may be NMOS transistors. The reference voltage 220-a may be offset from a default reference voltage with a positive offset applied, and the reference voltage 220-b may be offset from the default reference voltage with a negative offset applied. In an illustrative example, the default reference voltage may be 5 V, the reference voltage 220-a may be 4.5 V (e.g., with an offset of −0.5 V), and the reference voltage 220-b may be 5.5 V (e.g., with an offset of +0.5 V).

The memory system may selectively activate (e.g., turn on, supply power to) the decision circuit 205-a or the decision circuit 205-b using the selection circuit 235 based on the logical value sampled at the unit interval immediately preceding the current unit interval. The selection circuit 235 may receive a logical value 240-a (e.g., a candidate state of the CA signal at the preceding unit interval) at the switching component 210-e and a logical value 240-b (e.g., a candidate state of the CA signal at the preceding unit interval) at the switching component 210-f. The logical value 240-b may be the state of a sample of the CA signal taken at the unit interval that immediately preceded the sample of the CA signal currently being taken. The logical value 240-a and the logical value 240-b may be output from a latch circuit 250. In some cases, the logical value 240-a and the logical value 240-b may be delayed using a delay circuit 255-b prior to the logical value 240-b being received at the switching component 210-f. The delay circuit 255-b may delay the output of the latch circuit 250 by a duration less than a unit interval (e.g., a one inverter delay), such that the output of the latch circuit 250 is available at the selection circuit 235 at the next successive unit interval (e.g., of the clock signal 225) to perform evaluation of subsequent CA samples (e.g., prior to the next CA sample being received at the decision circuit 205-a and the decision circuit 205-b). In some examples, the delay circuit 255-b may be a single inverter.

The selection circuit 235 and the decision circuits 205-a and 205-b may be synchronized using a clock signal and switching components 210-g and 210-h. The switching component 210-g and the switching component 210-h may be tail transistors. In some examples, the switching component 210-g and the switching component 210-g may be NMOS transistors. The switching component 210-g and the switching component 210-h may activate the selection circuit 235 periodically, in accordance with the clock signal 225. In this manner, one or more circuits within the architecture 200 may be activated at unit intervals (e.g., at falling edges of the clock signal 225, at rising edges of the clock signal 225), and at each unit interval the architecture 200 may sample a value from the CA signal 215. Thus, the combination of the clock signal 225 and the logical value at the selection circuit 235 may cause the one of the decision circuits to output values to the latch circuit 250.

The sampled CA signal may output to the latch circuit 250. The sampled values received at the input node 260-a and the input node 260-b of the latch circuit 250 may be different based on which decision circuit 205 is selected to sample the CA signal. In examples where the decision circuit 205-a is activated, inputs at the node 260-a and at the node 260-b may be based on a difference between the CA signal 215 (e.g., a sample of the CA signal at a first unit interval) and the reference voltage 220-a. If the decision circuit 205-a compares the value of the CA signal 215 with the reference voltage 220-a and the CA signal 215 is greater than the reference voltage 220-a, a voltage at the node 260-a may be greater than a voltage at the node 260-b. If the decision circuit 205-a compares the CA signal 215 with the reference voltage 220-a and the value of the reference voltage 220-a is greater than the CA signal 215, a voltage at the node 260-a may be less than a voltage at the node 260-b.

In other examples, the decision circuit 205-b may be selected. In such cases, inputs at the node 260-a and at the node 260-b may be based on a difference between the CA signal 215 and the reference voltage 220-b. If the decision circuit 205-b compares the CA signal 215 with the reference voltage 220-b and the value of the CA signal 215 is greater than the reference voltage 220-b, a voltage at the node 260-a may be greater than a voltage at the node 260-b. If the decision circuit 205-b compares the CA signal 215 with the reference voltage 220-b and the value of the reference voltage 220-b is greater than the CA signal 215, the voltage at the node 260-a may be less than the voltage at the node 260-b.

The latch circuit 250 may perform a comparison between a first voltage received by the latch circuit 250 at the node 260-a and a second voltage received by the latch circuit 250 at the node 260-b. Based on the voltages at node 260-a and node 260-b, the latch circuit 250 may determine whether a voltage at the node 260-c is higher than a voltage at the node 260-d. In some examples, the voltage at the node 260-c may be higher than the voltage at the node 260-d, and the latch circuit 250 may determine to output a first logical value (e.g., 0) for the CA sample (e.g., of the CA signal 215 received during the first unit interval).

Alternatively, the voltage at the node 260-d may be higher than the voltage at the node 260-c, and the latch circuit 250 may determine to output a second logical value (e.g., 1) for the CA sample. The latch circuit 250 may be a strongARM latch, and may include one or more NMOS transistors and one or more PMOS transistors.

A first output of the latch circuit 250, which may be the logical value of the CA sample, may be coupled with the delay circuit 255-a, and the memory system may feedback the logical value 240-a to the switching component 210-e based on applying a delay. The logical value 240-a may be an inverse of the logical value of the CA sample (e.g., based on an output of the delay circuit 255-a). In this manner, the selection circuit 235 may activate the decision circuit 205-a and compare the subsequent CA sample (e.g., during a second unit interval after the first unit interval) with the reference voltage 220-a (e.g., Vref_m) based on the output from the latch circuit 250 being low.

A second output of the latch circuit 250, which may be an inverse of the logical value of the CA sample, may be coupled with the delay circuit 255-b, and the memory system may feedback the logical value 240-b to the switching component 210-f based on applying a delay. The logical value 240-b may correspond to the logical value of the CA sample (e.g., based on an output of the delay circuit 255-b). In this manner, the selection circuit 235 may activate the decision circuit 205-b and compare the subsequent CA sample (e.g., during a second unit interval after the first unit interval) with the reference voltage 220-b (e.g., Vref_p) based on the output from the latch circuit 250 being high.

The architecture 200 may include a switching component 210-j and a switching component 210-k, which may activate (e.g., latch) the output of the latch circuit 250 periodically, in accordance with the clock signal 245. The clock signal 245 may be an inverse of the clock signal 225. The switching component 210-g and the switching component 210-h may be NMOS transistors.

In some examples, two sampling circuits may be implemented in the memory system in accordance with the architecture 200 (e.g., and may be operated in parallel to sample the CA signal 215). In such examples, a first circuit may sample the CA signal 215 at rising edges of the clock signal 225 and a second circuit may sample the CA signal 215 at falling edges of the clock signal. By implementing two circuits in the memory system for sampling in accordance with the architecture 200, the memory system may support a faster rate of sampling and increased memory access speeds by distributing the sampling load between two circuits that can operate in parallel to evaluate different unit intervals. In such architectures, the output of a first circuit for sampling may be output to the second circuit for sampling and vice-versa. Basically, the output of the first circuit may be used by the selection circuit 235 of the second circuit to select which of the decision circuits 205 to activate in the second circuit, and vice-versa.

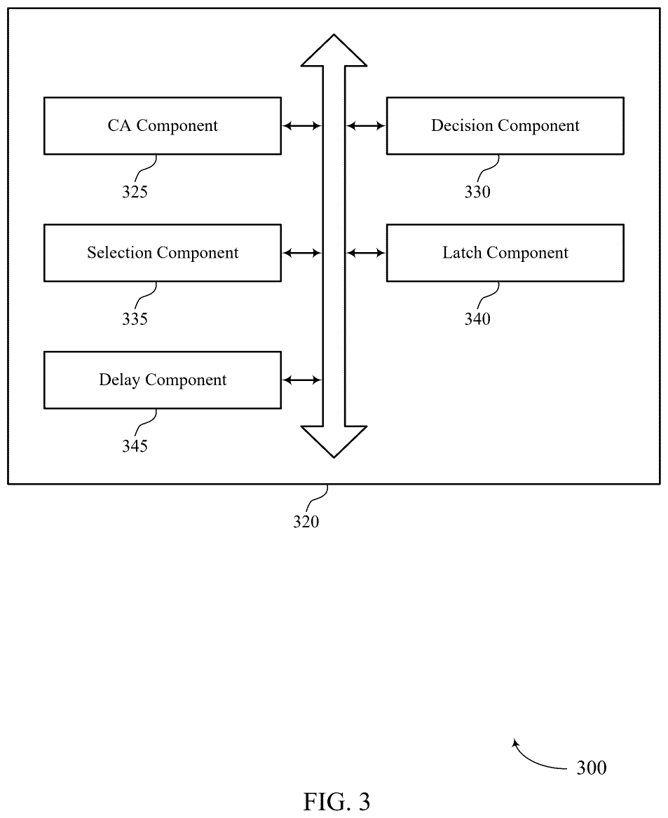

FIG. 3 shows a block diagram 300 of a memory system 320 that supports CA sampling in accordance with examples as disclosed herein. The memory system 320 may be an example of aspects of a memory system as described with reference to FIGS. 1 through 2. The memory system 320, or various components thereof, may be an example of means for performing various aspects of CA sampling as described herein. For example, the memory system 320 may include a CA component 325, a decision component 330, a switching component 335, a latch component 340, a delay component 345, or any combination thereof. Each of these components, or components of subcomponents thereof (e.g., one or more processors, one or more memories), may communicate, directly or indirectly, with one another (e.g., via one or more buses).

The CA component 325 may be configured as or otherwise support a means for receiving a CA signal at a first decision circuit and a second decision circuit. The decision component 330 may be configured as or otherwise support a means for comparing, using the first decision circuit, the CA signal sampled during a first unit interval with a first reference voltage that has a positive offset. In some examples, the decision component 330 may be configured as or otherwise support a means for comparing, using the second decision circuit, the CA signal sampled during the first unit interval with a second reference voltage that has a negative offset. The switching component 335 may be configured as or otherwise support a means for selectively activating, using a selection circuit, the first decision circuit or the second decision circuit based at least in part on a state of the CA signal sampled during a second unit interval that precedes the first unit interval. The latch component 340 may be configured as or otherwise support a means for outputting, from a latch circuit for the first unit interval, a state of the CA signal during the first unit interval.

In some examples, the switching component 335 may be configured as or otherwise support a means for receiving, from the latch circuit using the selection circuit, the state of the CA signal during the second unit interval, where selectively activating the first decision circuit or the second decision circuit is based at least in part on the receiving.

In some examples, the switching component 335 may be configured as or otherwise support a means for activating the first decision circuit that compares the CA signal with the first reference voltage that has the positive offset based at least in part on the state of the CA signal during the second unit interval being a high value.

In some examples, the switching component 335 may be configured as or otherwise support a means for activating the second decision circuit that compares the CA signal with the second reference voltage that has the negative offset based at least in part on the state of the CA signal during the second unit interval being a low value.

In some examples, the latch component 340 may be configured as or otherwise support a means for receiving, using the latch circuit, an output of the first decision circuit based at least in part on the state of the CA signal during the second unit interval being a high value.

In some examples, the latch component 340 may be configured as or otherwise support a means for receiving, using the latch circuit, an output of the second decision circuit based at least in part on the state of the CA signal during the second unit interval being a low value.

In some examples, the delay component 345 may be configured as or otherwise support a means for applying a delay to an output of the latch circuit, the delay being less than one unit interval. In some examples, the switching component 335 may be configured as or otherwise support a means for receiving, using the selection circuit, the delayed output of the latch circuit including the state of the CA signal sampled during the second unit interval, where selectively activating the first decision circuit or the second decision circuit is based at least in part on receiving the delayed output of the latch circuit using the selection circuit.

In some examples, the first reference voltage corresponds to a default reference voltage with the positive offset applied and the second reference voltage corresponds to the default reference voltage with the negative offset applied.

In some examples, the first decision circuit, the second decision circuit, or both include a decision feedback equalization circuit.

In some examples, the latch circuit includes a strongARM latch.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

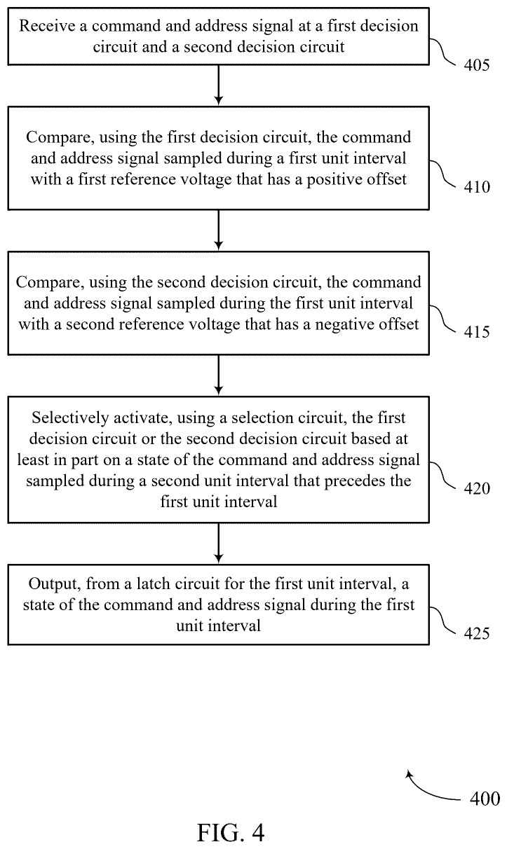

FIG. 4 shows a flowchart illustrating a method 400 that supports CA sampling in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include receiving a CA signal at a first decision circuit and a second decision circuit. In some examples, aspects of the operations of 405 may be performed by a CA component 325 as described with reference to FIG. 3.

At 410, the method may include comparing, using the first decision circuit, the CA signal sampled during a first unit interval with a first reference voltage that has a positive offset. In some examples, aspects of the operations of 410 may be performed by a decision component 330 as described with reference to FIG. 3.

At 415, the method may include comparing, using the second decision circuit, the CA signal sampled during the first unit interval with a second reference voltage that has a negative offset. In some examples, aspects of the operations of 415 may be performed by a decision component 330 as described with reference to FIG. 3.

At 420, the method may include selectively activating, using a selection circuit, the first decision circuit or the second decision circuit based at least in part on a state of the CA signal sampled during a second unit interval that precedes the first unit interval. In some examples, aspects of the operations of 420 may be performed by a switching component 335 as described with reference to FIG. 3.

At 425, the method may include outputting, from a latch circuit for the first unit interval, a state of the CA signal during the first unit interval. In some examples, aspects of the operations of 425 may be performed by a latch component 340 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a CA signal at a first decision circuit and a second decision circuit; comparing, using the first decision circuit, the CA signal sampled during a first unit interval with a first reference voltage that has a positive offset; comparing, using the second decision circuit, the CA signal sampled during the first unit interval with a second reference voltage that has a negative offset; selectively activating, using a selection circuit, the first decision circuit or the second decision circuit based at least in part on a state of the CA signal sampled during a second unit interval that precedes the first unit interval; and outputting, from a latch circuit for the first unit interval, a state of the CA signal during the first unit interval.

Aspect 2: The method, apparatus, or non-transitory computer-readable medium of aspect 1, further including operations, features, circuitry, logic, means, or instructions, or any combination thereof for receiving, from the latch circuit using the selection circuit, the state of the CA signal during the second unit interval, where selectively activating the first decision circuit or the second decision circuit is based at least in part on the receiving.

Aspect 3: The method, apparatus, or non-transitory computer-readable medium of any of aspects 1 through 2, further including operations, features, circuitry, logic, means, or instructions, or any combination thereof for activating the first decision circuit that compares the CA signal with the first reference voltage that has the positive offset based at least in part on the state of the CA signal during the second unit interval being a high value.

Aspect 4: The method, apparatus, or non-transitory computer-readable medium of any of aspects 1 through 3, further including operations, features, circuitry, logic, means, or instructions, or any combination thereof for activating the second decision circuit that compares the CA signal with the second reference voltage that has the negative offset based at least in part on the state of the CA signal during the second unit interval being a low value.

Aspect 5: The method, apparatus, or non-transitory computer-readable medium of any of aspects 1 through 4, further including operations, features, circuitry, logic, means, or instructions, or any combination thereof for receiving, using the latch circuit, an output of the first decision circuit based at least in part on the state of the CA signal during the second unit interval being a high value.

Aspect 6: The method, apparatus, or non-transitory computer-readable medium of any of aspects 1 through 5, further including operations, features, circuitry, logic, means, or instructions, or any combination thereof for receiving, using the latch circuit, an output of the second decision circuit based at least in part on the state of the CA signal during the second unit interval being a low value.

Aspect 7: The method, apparatus, or non-transitory computer-readable medium of any of aspects 1 through 6, further including operations, features, circuitry, logic, means, or instructions, or any combination thereof for applying a delay to an output of the latch circuit, the delay being less than one unit interval and receiving, using the selection circuit, the delayed output of the latch circuit including the state of the CA signal sampled during the second unit interval, where selectively activating the first decision circuit or the second decision circuit is based at least in part on receiving the delayed output of the latch circuit using the selection circuit.

Aspect 8: The method, apparatus, or non-transitory computer-readable medium of any of aspects 1 through 7, where the first reference voltage corresponds to a default reference voltage with the positive offset applied and the second reference voltage corresponds to the default reference voltage with the negative offset applied.

Aspect 9: The method, apparatus, or non-transitory computer-readable medium of any of aspects 1 through 8, where the first decision circuit, the second decision circuit, or both include a decision feedback equalization circuit.

Aspect 10: The method, apparatus, or non-transitory computer-readable medium of any of aspects 1 through 9, where the latch circuit includes a strongARM latch.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 11: An apparatus, including: a receiver configured to receive a CA signal, the receiver including: a first decision circuit configured to compare the CA signal sampled during a first unit interval with a first reference voltage that has a positive offset; a second decision circuit configured to compare the CA signal sampled during the first unit interval with a second reference voltage that has a negative offset; a selection circuit configured to selectively activate the first decision circuit or the second decision circuit based at least in part on a state of the CA signal sampled during a second unit interval that precedes the first unit interval; and a latch circuit coupled with an output of the receiver, the latch circuit configured to output, for the first unit interval, a state of the CA signal during the first unit interval.

Aspect 12: The apparatus of aspect 11, where the selection circuit is configured to receive, from the latch circuit, the state of the CA signal during the second unit interval, selectively activating the first decision circuit or the second decision circuit is based at least in part on the receiving.

Aspect 13: The apparatus of any of aspects 11 through 17, where the selection circuit is configured to activate the first decision circuit that compares the CA signal with the first reference voltage that has the positive offset based at least in part on the state of the CA signal during the second unit interval being a high value.

Aspect 14: The apparatus of any of aspects 11 through 13, where the selection circuit is configured to activate the second decision circuit that compares the CA signal with the second reference voltage that has the negative offset based at least in part on the state of the CA signal during the second unit interval being a low value.

Aspect 15: The apparatus of any of aspects 11 through 14, where the latch circuit is configured to receive an output of the first decision circuit based at least in part on the state of the CA signal during the second unit interval being a high value.

Aspect 16: The apparatus of any of aspects 11 through 15, where the latch circuit is configured to receive an output of the second decision circuit based at least in part on the state of the CA signal during the second unit interval being a low value.

Aspect 17: The apparatus of aspect 11 through 16, where an output of the latch circuit is coupled to the selection circuit via a delay circuit, and the delay circuit is configured to apply a delay to the output of the latch circuit, the delay being less than one unit interval.

Aspect 18: The apparatus of any of aspects 11 through 17, where the first reference voltage corresponds to a default reference voltage with the positive offset applied and the second reference voltage corresponds to the default reference voltage with the negative offset applied.

Aspect 19: The apparatus of any of aspects 11 through 18, where the first decision circuit, the second decision circuit, or both include a decision feedback equalization circuit.

Aspect 20: The apparatus of any of aspects 11 through 19, where the latch circuit includes a strongARM latch.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “isolated” may refer to a relationship between components in which signals are not presently capable of flowing between the components. Components are isolated from each other if there is an open circuit between them. For example, two components separated by a switch that is positioned between the components are isolated from each other when the switch is open. When a component isolates two components, the component may initiate a change that prevents signals from flowing between the other components using a conductive path that previously permitted signals to flow.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

The terms “layer” and “level” may refer to an organization (e.g., a stratum, a sheet) of a geometrical structure (e.g., relative to a substrate). Each layer or level may have three dimensions (e.g., height, width, and depth) and may cover at least a portion of a surface. For example, a layer or level may be a three dimensional structure where two dimensions are greater than a third, e.g., a thin-film. Layers or levels may include different elements, components, or materials. In some examples, one layer or level may be composed of two or more sublayers or sublevels.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a receiver configured to receive a command and address signal, the receiver comprising:
a first decision circuit configured to compare the command and address signal sampled during a first unit interval with a first reference voltage that has a positive offset;
a second decision circuit configured to compare the command and address signal sampled during the first unit interval with a second reference voltage that has a negative offset;
a selection circuit configured to selectively activate the first decision circuit or the second decision circuit based at least in part on a state of the command and address signal sampled during a second unit interval that precedes the first unit interval; and
a latch circuit coupled with an output of the receiver, the latch circuit configured to output, for the first unit interval, a state of the command and address signal during the first unit interval.

2. The apparatus of claim 1, wherein:
the selection circuit is configured to receive, from the latch circuit, the state of the command and address signal during the second unit interval, and
selectively activating the first decision circuit or the second decision circuit is based at least in part on the receiving.

3. The apparatus of claim 2, wherein:
an output of the latch circuit is coupled to the selection circuit via a delay circuit, and
the delay circuit is configured to apply a delay to the output of the latch circuit, the delay being less than one unit interval.

4. The apparatus of claim 1, wherein the selection circuit is configured to activate the first decision circuit that compares the command and address signal with the first reference voltage that has the positive offset based at least in part on the state of the command and address signal during the second unit interval being a high value.

5. The apparatus of claim 1, wherein the selection circuit is configured to activate the second decision circuit that compares the command and address signal with the second reference voltage that has the negative offset based at least in part on the state of the command and address signal during the second unit interval being a low value.

6. The apparatus of claim 1, wherein the latch circuit is configured to receive an output of the first decision circuit based at least in part on the state of the command and address signal during the second unit interval being a high value.

7. The apparatus of claim 1, wherein the latch circuit is configured to receive an output of the second decision circuit based at least in part on the state of the command and address signal during the second unit interval being a low value.

8. The apparatus of claim 1, wherein the first reference voltage corresponds to a default reference voltage with the positive offset applied and the second reference voltage corresponds to the default reference voltage with the negative offset applied.

9. The apparatus of claim 1, wherein the first decision circuit, the second decision circuit, or both comprise a decision feedback equalization circuit.

10. The apparatus of claim 1, wherein the latch circuit comprises a strongARM latch.

11. A method, comprising:
receiving a command and address signal at a first decision circuit and a second decision circuit;
comparing, using the first decision circuit, the command and address signal sampled during a first unit interval with a first reference voltage that has a positive offset;
comparing, using the second decision circuit, the command and address signal sampled during the first unit interval with a second reference voltage that has a negative offset;
selectively activating, using a selection circuit, the first decision circuit or the second decision circuit based at least in part on a state of the command and address signal sampled during a second unit interval that precedes the first unit interval; and
outputting, from a latch circuit for the first unit interval, a state of the command and address signal during the first unit interval.

12. The method of claim 11, further comprising:
receiving, from the latch circuit using the selection circuit, the state of the command and address signal during the second unit interval, wherein selectively activating the first decision circuit or the second decision circuit is based at least in part on the receiving.

13. The method of claim 11, further comprising:
activating the first decision circuit that compares the command and address signal with the first reference voltage that has the positive offset based at least in part on the state of the command and address signal during the second unit interval being a high value.

14. The method of claim 11, further comprising:
activating the second decision circuit that compares the command and address signal with the second reference voltage that has the negative offset based at least in part on the state of the command and address signal during the second unit interval being a low value.

15. The method of claim 11, further comprising:
receiving, using the latch circuit, an output of the first decision circuit based at least in part on the state of the command and address signal during the second unit interval being a high value.

16. The method of claim 11, further comprising:
receiving, using the latch circuit, an output of the second decision circuit based at least in part on the state of the command and address signal during the second unit interval being a low value.

17. The method of claim 11, further comprising:
applying a delay to an output of the latch circuit, the delay being less than one unit interval; and
receiving, using the selection circuit, the delayed output of the latch circuit comprising the state of the command and address signal sampled during the second unit interval, wherein selectively activating the first decision circuit or the second decision circuit is based at least in part on receiving the delayed output of the latch circuit using the selection circuit.

18. The method of claim 11, wherein the first reference voltage corresponds to a default reference voltage with the positive offset applied and the second reference voltage corresponds to the default reference voltage with the negative offset applied.

19. The method of claim 11, wherein:
the first decision circuit, the second decision circuit, or both comprise a decision feedback equalization circuit; and
the latch circuit comprises a strongARM latch.

20. A non-transitory computer-readable medium storing code, the code comprising instructions executable by one or more processors to:
receive a command and address signal at a first decision circuit and a second decision circuit;
compare, using the first decision circuit, the command and address signal sampled during a first unit interval with a first reference voltage that has a positive offset;
compare, using the second decision circuit, the command and address signal sampled during the first unit interval with a second reference voltage that has a negative offset;
selectively activate, using a selection circuit, the first decision circuit or the second decision circuit based at least in part on a state of the command and address signal sampled during a second unit interval that precedes the first unit interval; and
output, from a latch circuit for the first unit interval, a state of the command and address signal during the first unit interval.
